(19) United States
(12) Patent Application Publication
(10) Pub. No.: US 2013/0030928 A1
(43) Pub. Date: Jan. 31, 2013

(54) METHODS AND SYSTEMS FOR ELECTRONICALLY MARKETING A PRODUCT THROUGH AFFILIATE SPONSORSHIPS VIA A COMPUTER NETWORK

(71) Applicant: Eric R. Lopez, Albuquerque, NM (US)

(72) Inventor: Eric R. Lopez, Albuquerque, NM (US)

(21) Appl. No.: 13/545,394

(22) Filed: Jul. 10, 2012

Related U.S. Application Data
(60) Provisional application No. 61/511,363, filed on Jul. 25, 2011.

(51) Int. Cl. G06Q 30/02

(52) U.S. Cl. 705/14.69

(57) ABSTRACT

One or more purchasers among a group of purchasers that compose a market base can be redirected to an online store for purchase of products, in response to a selection of a unique sponsorship link associated with a particular user. One or more purchases made through the online store by the purchaser(s) can be automatically tracked via the unique sponsorship link. Thereafter a commission can be automatically transmitted to an account associated with the particular user, when the purchase(s) is made through the online store by the purchaser(s). The particular user can thus be paid automatically (e.g., once a month, periodically, etc) for any purchases made from anyone who visits the online store via the unique sponsorship link and purchases products via the online store.

### CROSS-REFERENCE TO PROVISIONAL APPLICATION

This patent application claims the benefit under 35 U.S.C. §119(e) of U.S. Provisional Application Ser. No. 61/511,363 entitled, “Methods and Systems for Electronically Marketing a Product Through Affiliate Sponsorships Via a Computer Network,” which was filed on Jul. 25, 2011 and is incorporated herein by reference in its entirety.

### TECHNICAL FIELD

Embodiments are generally related to data-processing methods and systems. Embodiments are additionally related to computer networks, such as, for example, the Internet, and website portals. Embodiments are also related to the marketing of products through affiliate sponsorships via such computer networks.

### BACKGROUND OF THE INVENTION

Athletes and others who compete or perform publicly require income in order to purchase equipment or pay entry fees for public events. Many athletes are paid by companies to wear or otherwise display decals, apparel, hats or other items bearing the companies' trademarks or other indicia. Such companies pay for their trademarks to be worn by the athletes because of the substantial public exposure the trademarks are likely to gain due to public interest in the athlete. For example, NASCAR racing vehicles bear many trademarks due to the high likelihood of the vehicle being filmed by television cameras broadcasting the race to racing fans. The vehicles bear the trademarks, because the companies are willing to pay fees to the vehicle's owner for the probability that their sponsored vehicle will be viewed by racing fans.

Unfortunately, other than a relatively few athletes in each sport, sponsorship by companies is difficult to achieve in athletic events due to the uncertainty that a given “unknown” athlete will gain public exposure. Even an excellent athlete must gain notoriety before he or she is “desirable” to a company interested in sponsoring an athlete. The apparent contradiction is that sponsors will not sponsor unknown athletes, but in order to become known, athletes need sponsorship funds. Other than a few stellar athletes, such as Michael Jordan, Tiger Woods and their peers, sponsorship hopes are lacking. Thus, the need exists for a way for unknown athletes and other public performers to obtain sponsorships and thus generate income.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for methods and systems for the marketing of products through affiliate sponsorships over a computer network, such as the Internet.

It is another aspect of the disclosed embodiments to provide for the marketing of products through affiliate sponsorships via a social network.

It is still a further aspect of the disclosed embodiments to provide for methods and systems for providing automatic payment of a commission to particular users facilitated via unique sponsorship links.

The aforementioned aspects and other objectives and advantages can now be achieved as described herein. Methods and systems are disclosed for electronically marketing a product through affiliate sponsorships via a computer network are disclosed herein. In general, one or more purchasers among a group of purchasers that compose a market base can be redirected to an online store for purchase of products via the online store, in response to a selection of a unique sponsorship link associated with a particular user. One or more purchases made through the online store by the purchaser(s) can be automatically tracked via the unique sponsorship link. Thereafter a commission can be automatically transmitted to an account associated with the particular user, when the purchase(s) is made through the online store by the purchaser(s). The particular user can thus be paid automatically (e.g., once a month, periodically, etc) for any purchases made from anyone who visits the online store via the unique sponsorship link and purchases products via the online store.

The unique sponsorship link can be associated with the particular user during or after setting up the aforementioned account. The unique sponsorship link can be then provided to the market base comprised of the aforementioned group of users. In some embodiments, a profile associated with the particular user can be created via an online registry to aid in the promotion of the products and provide status information associated with the particular user. In other embodiments, such a registry can be customized to a particular community. Additionally, the account associated with the particular user can be created during creation of the aforementioned profile. The unique sponsorship link can be placed in a particular space of, for example, a website, social network, etc. Tracking via the unique sponsorship link can be implemented via, for example, a web cookie associated with the unique sponsorship link to track purchases made through the online store by one or more purchasers redirected to the online store via the unique sponsorship link.

A number of embodiments, preferred and/or alternative, are disclosed. For example, an embodiment can be implemented as a method for electronically marketing a product through affiliate sponsorships via a computer network. Such a method may include the steps of, for example, redirecting at least one purchaser among a plurality of purchasers that comprise a market base to an online store for purchase of products via the online store, in response to a selection of a unique sponsorship link associated with a particular user; automatically tracking via the unique sponsorship link, at least one purchase made through the online store by the at least one purchaser; and transmitting a commission to an account associated with the particular user, when the at least one purchase is made through the online store by the at least one purchaser and facilitated by the unique sponsorship link.

In another embodiment, steps can be implemented for associating the unique sponsorship link with the particular user, and providing the unique sponsorship link to the market base comprising the plurality of purchasers. In another embodiment, a step can be provided for creating via an online registry, a profile associated with the particular user to aid in a promotion of the products and provide status information associated with the particular user. In still other embodiments, a step can be provided for customizing the registry with respect to a particular community.

In other embodiments, a step can be provided for creating the account associated with the particular user. In yet other embodiments, a step can be provided for placing the unique sponsorship link in a particular space of a website. In other embodiments, a step can be provided for placing the unique sponsorship link in a particular space of a social network. In still other embodiments, the step of automatically tracking via the unique sponsorship link can further include a step of associating a web cookie with the unique sponsorship link to track at least one purchase made through the online store by the at least one purchaser.

In still other embodiments, a system can be provided for electronically marketing a product through affiliate sponsorships via a computer network. Such a system can include, for example, a processor, and a data bus coupled to the processor. Such a system can also include a computer-usable medium embodying computer code. The computer-usable medium can be coupled to the data bus. The computer program code can comprise instructions executable by the processor and configured for redirecting at least one purchaser among a plurality of purchasers that compose a market base to an online store for purchase of products via the online store, in response to a selection of a unique sponsorship link associated with a particular user; automatically tracking via the unique sponsorship link, at least one purchase made through the online store by the at least one purchaser; and transmitting a commission to an account associated with the particular user, when the at least one purchase is made through the online store by the at least one purchaser and facilitated by the unique sponsorship link.

In other embodiments, such instructions can be further configured for associating the unique sponsorship link with the particular user, and providing the unique sponsorship link to the market base comprising the plurality of purchasers. In other embodiments, such instructions can be further configured for creating via an online registry, a profile associated with the particular user to aid in a promotion of the products and provide status information associated with the particular user. In other embodiments, such instructions can be further configured for customizing the registry with respect to a particular community. In still other embodiments, such instructions can be further configured for creating the account associated with the particular user and the profile.

In yet other embodiments such instructions can be further configured for placing the unique sponsorship link in a particular space of a website. In still other embodiments, such instructions can be further configured for placing the unique sponsorship link in a particular space of a social network. In still other embodiments, the aforementioned instructions for automatically tracking via the unique sponsorship link, can further comprise instructions for associating a web cookie with the unique sponsorship link to track at least one purchase made through the online store by the at least one purchaser. Alternatively, instructions for associating a web cookie with the unique sponsorship link to track at least one purchase made through the online store by the at least one purchaser, can be standalone instructions separate from instructions for automatically tracking via the unique sponsorship link.

In still another embodiment, a processor-readable medium can be provided for storing code representing instructions to cause a processor to perform a process for electronically marketing a product through affiliate sponsorships via a computer network. Such code may comprise code to, for example: redirect at least one purchaser among a plurality of purchasers that comprise a market base to an online store for purchase of products via the online store, in response to a selection of a unique sponsorship link associated with a particular user; automatically track via the unique sponsorship link, at least one purchase made through the online store by the at least one purchaser; and transmit a commission to an account associated with the particular user, when the at least one purchase is made through the online store by the at least one purchaser and facilitated by the unique sponsorship link.

In another embodiment, such code can further comprise code to associate the unique sponsorship link with the particular user, and provide the unique sponsorship link to the market base comprising the plurality of purchasers. In yet other embodiments, such code can further comprise code to create via an online registry, a profile associated with the particular user to aid in a promotion of the products and provide status information associated with the particular user. In still other embodiments, such code can further comprise code to customize the registry with respect to a particular community. In yet other embodiments, such code can further comprise code to create the account associated with the particular user. In yet other embodiments, such code can comprise code to place the unique sponsorship link in a particular space of a website. In still other embodiments, such code can further comprise code to place the unique sponsorship link in a particular space of a social network. In other embodiments, such code can further comprise code to associate a web cookie with the unique sponsorship link to track at least one purchase made through the online store by the at least one purchaser.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a high-level block diagram of an exemplary data processing system that may be included in devices operating in accordance with the disclosed embodiments;

FIG. 2 illustrates an exemplary environment for operations and devices in accordance with the disclosed embodiments;

FIG. 3 illustrates a graphical representation of a system in which embodiments may be implemented;

FIG. 4 illustrates a block diagram of a method for electronically marketing a product through affiliate sponsorships via a computer network, in accordance with the disclosed embodiments;

FIG. 5 illustrates a block diagram of a system for marketing products through affiliate sponsorship via a computer network, in accordance with the disclosed embodiments;

FIG. 6 illustrates a block diagram of a social networking system, which can be adapted for use in accordance with an embodiment;

FIG. 7 illustrates a high level flow chart of logical operational steps of a social networking sponsorship method that can be implemented in accordance with an embodiment;

FIG. 8 illustrates additional logical operational steps of a social networking sponsorship method than can be implemented in accordance with an embodiment;

FIG. 9 illustrates additional logical operational steps of a social networking sponsorship method than can be implemented in accordance with an embodiment;

FIG. 10 illustrates a pictorial view of an example sponsorship webpage in accordance with an embodiment;

FIG. 11 illustrates a pictorial view of an example sponsorship webpage in accordance with an embodiment;

FIG. 12 illustrates a pictorial view of an example sponsorship webpage including an informational placeholder and a linking code, in accordance with an embodiment;

FIG. 13 illustrates a pictorial view of an example sponsorship webpage including data input buttons for accessing a registry/database in accordance with an embodiment;

FIG. 14 illustrates a pictorial view of an example sponsorship webpage including graphical input buttons to select and sign up for a sponsorship in accordance with an embodiment; and

FIG. 15 illustrates a pictorial view of an example sponsorship webpage including additional information regarding a sponsorship program, in accordance with an embodiment.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention can be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized, including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.) The computer program code, however, for carrying out operations of the present invention may also be written in conventional procedural programming languages, such as the “C” programming language or in a visually oriented programming environment, such as, for example, VisualBasic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The invention is described in part below with reference to flowchart illustrations and/or block diagrams of methods, systems, computer program products and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture, including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

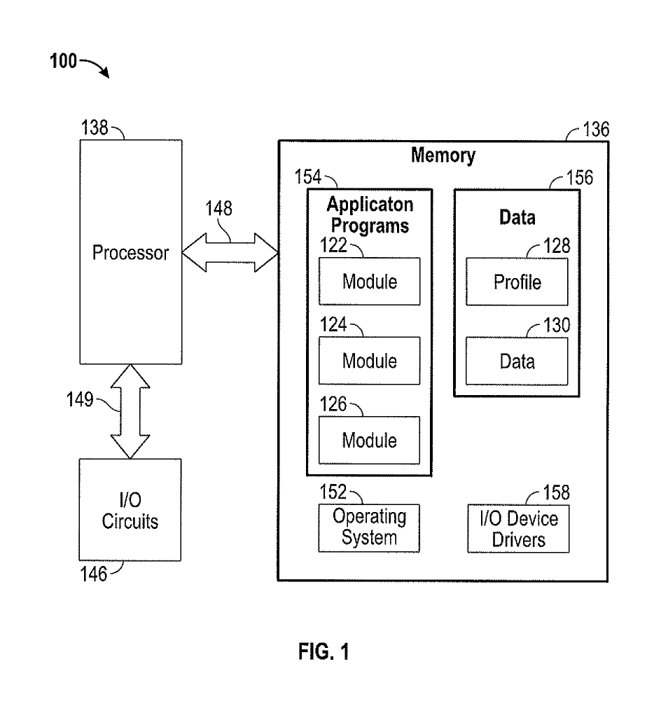

Referring now to FIG. 1, an exemplary data processing system 100 is disclosed, which may be included in devices operating in accordance with the disclosed embodiments and/or in accordance with particular embodiments. As illustrated, in FIG. 1 the data processing system 100 includes a processor 138, a memory 136 and input/output circuits 146. The data processing system 100 may be incorporated in, for example, a desktop or personal computer, a server, a portable wireless hand held device (e.g., Smartphone, laptop computer, tablet computing device, Personal Digital Assistant, etc), or the like. The processor 138 can communicate with the memory 136 via, for example, an address/data bus 148 and can also communicate with the input/output circuits 146, for example, via an address/data bus 149. The input/output circuits 146 can be used to transfer information between the memory 136 and another computer system or a network using, for example, an Internet Protocol (IP) connection and/or wireless or wired communications. These components may be components such as those used in many data processing systems, which may be configured and/or modified to operate as described herein.

In particular, the processor 138 can be any commercially available or custom microprocessor, microcontroller, digital signal processor or the like. The memory 136 may include any memory devices containing the software and data used to implement the functionality circuits or modules used in accordance with embodiments of the present invention. The memory 136 can include, but is not limited to, the following types of devices: cache, ROM, PROM, EPROM, EEPROM, flash memory, SRAM, DRAM and magnetic disk. In some embodiments of the present invention, the memory 136 may be, for example, a content addressable memory (CAM). It can be appreciated, of course, that these are merely examples of types of memories that may be utilized and that other types of memories may be implemented in accordance with alternative embodiments.

As further illustrated in FIG. 1, the memory 136 may include several categories of software and data used in the data processing system 100: an operating system 152; application programs 154; input/output device drivers 158; and data 156. As will be appreciated by those of skill in the art, the operating system 152 may be any operating system suitable for use with a data processing system, such as, for example, Linux, Windows XP, Mac OS, Unix, etc. The input/output device drivers 158 typically include software routines accessed through the operating system 152 by the application programs 154 to communicate with devices such as the input/output circuits 146 and certain memory 136 components. The application programs 154 are illustrative of the programs that implement the various features of the circuits and modules according to some embodiments of the present invention. Finally, the data 156 represents static and dynamic data that can be used by the application programs 154, the operating system 152, the input/output device drivers 158, and other software programs that may reside in the memory 136. As illustrated in FIG. 1, the data 156 may include, for example, profile data 128 and other information 130 for use by the circuits and modules of the application programs 154 according to some embodiments as discussed further herein.

In the embodiment shown in FIG. 1, applications programs 254 can include, for example, a one or more modules 122, 124, 126, etc. Note that while the embodiments are illustrated with reference to such modules 122, 124, 126, etc. being application programs in the context of system 100 shown FIG. 1, as will be appreciated by those of skill in the art, other configurations fall within the scope of the disclosed embodiments. For example, rather than being application programs 154, these modules may also be incorporated into the operating system 152 or other such logical division of the data processing system 100.

Furthermore, although modules 122, 124, 126, etc. are illustrated in a single data processing system, as will be appreciated by those of skill in the art, such functionality can be distributed across one or more data processing systems. Thus, the embodiments should not be construed as limited to the configuration illustrated in FIG. 1, but may be provided by other arrangements and/or divisions of functions between data processing systems. For example, although FIG. 1 is illustrated as having various circuits/modules, one or more of these circuits may be combined without departing from the scope of the disclosed embodiments.

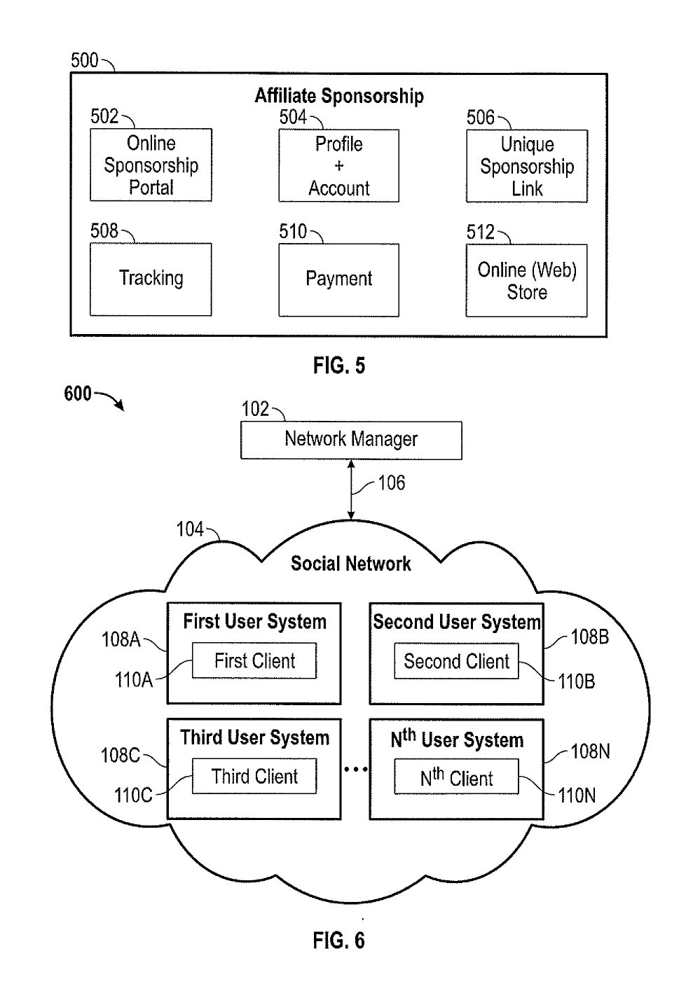

Modules 122, 124, 126, etc can be utilized to provide a particular functionality or operations. For example, modules 122, 124, 126, etc can in some embodiments, be utilized as the online sponsorship portal module 502 shown in FIG. 5 and/or modules 504, 506, 508, 510 and/or 512 also depicted in FIG. 5 and described in more detail herein.

Note that as utilized herein the term “module” generally refers to a collection or routines (and/or subroutines) and/or data structures that performs a particular task or implements a particular abstract data type. Modules usually include two parts: an interface, which lists the constants, data types, variables, and routines that can be accessed by other modules or routines, and an implementation, which is typically, but not always, private (accessible only to the module) and which contains the source code that actually implements the routines in the module. The term “module” may also refer to a self-contained component that can provide a complete function to a system and can be interchanged with other modules that perform similar functions.

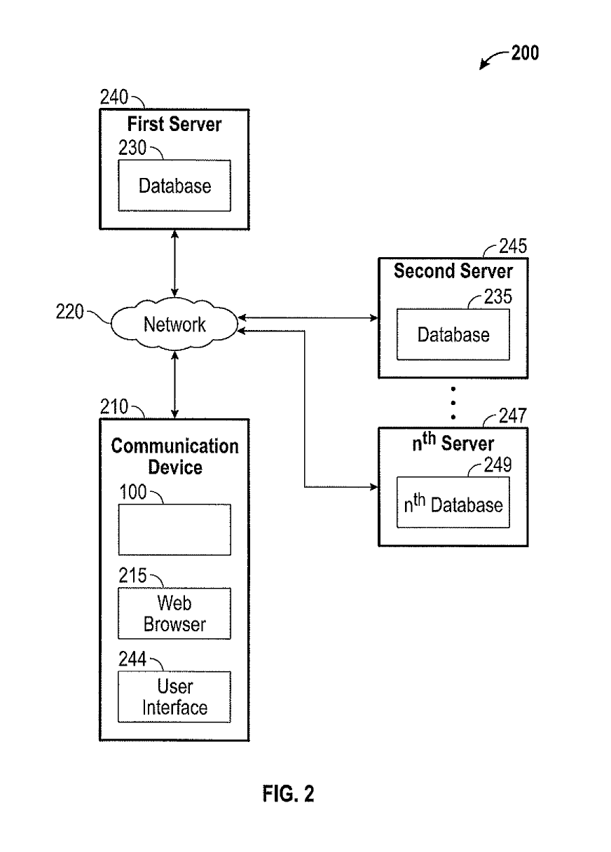

Referring now to FIG. 2, an exemplary environment 200 for operations and devices according to some embodiments will be discussed. As illustrated in FIG. 2, the environment 200 may include a communications/computing device 210, a data communications network 220, a first server 240 and a second server 245. It can be appreciated that additional servers may be utilized with respect to network 220. For example, an n^{th} server 247 is shown with an associated n^{th} database 249. It can also be appreciated that in some embodiments, only a single server, such as server 240 may be required. In general, the communications device 210 allows a user of the communications device 210 to communicate with servers, 240, 245, 247, etc., utilizing bi-directional communications of the remote device 210 over the data communications network 220. As will be discussed in more detail herein, network 220 can be, for example, the Internet, a wireless network (e.g., a WiFi network), a cellular communications network, etc.

As illustrated, the communications device 210 illustrated in FIG. 2 may include the data-processing system 100. For example, the application programs 154 discussed with respect to FIG. 1 can be included as part of the system 100 of the communications device 210. The communications device 210 may be, for example, a laptop computer, a desktop computer, a personal data assistant (PDA), Smartphone, a tablet computer, a web capable mobile terminal or any device capable of communicating with the network 220.

The communications device 210 may include, for example, a user interface 244, according to some embodiments of the present invention, and a web browser 215 that may be accessed through the user interface 244, according to some embodiments of the present invention. As discussed above, the system 100 may be configured to permit a user to access the online sponsorship portal discussed in greater detail herein, via the web browser 215.

The first server 240 may include a database 230 and the second server 245 may include a database 235. The communications device 210 may communicate over the network 220, for example, the Internet, through a wireless communications link, an Ethernet connection, a telephone line, a digital subscriber link (DSL), a broadband cable link, other wireless links, etc. The first and second servers 240 and 245 may also communicate over the network 220. Thus, the network 220 may convey data between the communications device 210 and the first and second servers 240 and 245. The network 220 can be, for example, a wireless communications network, such as, for example, a cellular communications network or 802.11/WiFi network. The network 220 can also be a client-server network.

The remote computing device 210 can be for example, a desktop computer, a laptop computer, a set-top box, or portable wireless handheld devices such as a Smartphone and/or PDA. The remote computing device 210 can also be, for example, a device such as an iPad type computing device.

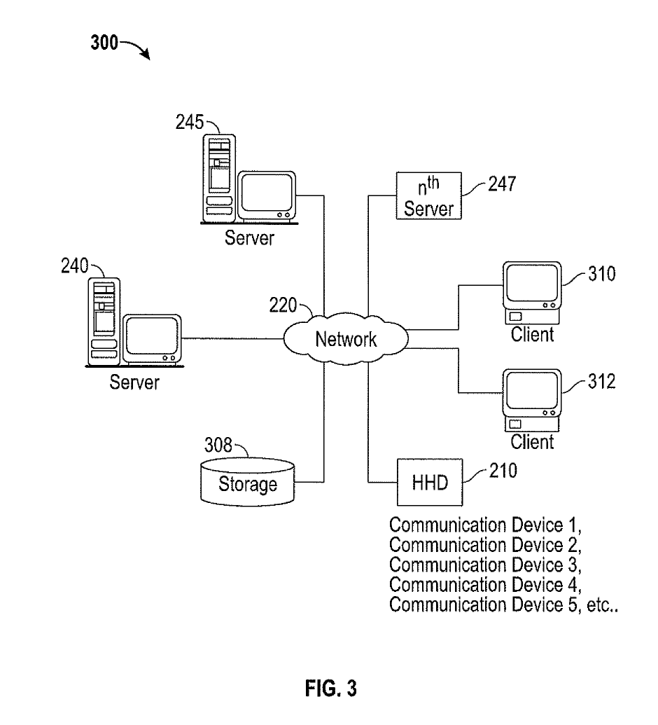

FIG. 3 illustrates a graphical representation of a system 300 in which embodiments may be implemented. System 300 can be implemented as a data network (e.g., the Internet) of computers. System 300 contains, for example, network 220, which can be the medium for providing communications links between various devices and computers connected together within network data processing system 300. Network 220 may include connections, such as wire, wireless communication links, fiber optic cables, and so forth.

In the depicted example, servers 240, 245, 247, etc, can connect to network 220 along with, for example, a storage unit 308, which may be, for example, a memory or other data storage device. In addition, clients 310, 312, 210, etc. can connect to and communicate with network 220. These clients 310, 312, and 210 may be, for example, personal computers or network computers. Client 210 can be, for example, an HHD (Hand Held Device), such as, for example, a Smartphone (e.g., iPhone, Android Phone, Blackberry), a tablet computing device, such as, for example, an iPad. The HHD or client 210 may also be, for example, a laptop computer, etc. Data-processing system 100 depicted in FIG. 1 can be, for example, a client such as client 310, 312, and/or 210 (or incorporated into such device). Alternatively, data-processing system 100 can be implemented as a server such as servers 240, 245, 247, etc, depending upon design considerations.

In some embodiments, server 240 can provide data such as boot files, operating system images, and applications to clients 310, 312, 210, etc. In the configuration depicted in FIG. 3, clients 310, 312, 210, etc. may be clients to, for example, server 240, 245 or 247, etc. Network data processing system 300 may include additional servers, clients, and other devices not shown. Specifically, clients may connect to any member of a network of servers which provide equivalent content.

In the depicted example, system 300 can be the well-known Internet with network 220 representing a worldwide collection of networks and gateways that use the Transmission Control Protocol/Internet Protocol (TCP/IP) suite of protocols to communicate with one another. In other embodiments, network 220 may itself be the Internet along with wired and/or wireless communications (e.g., cellular network, WiFi, etc) At the heart of the Internet, for example, is a backbone of high-speed data communication lines between major nodes or host computers, consisting of thousands of commercial, government, educational, and other computer systems that route data and messages. Of course, system 300 also may be implemented as a number of different types of networks such as, for example, an intranet, a local area network (LAN), a wireless network, a wide area network (WAN), and so forth. Note that FIGS. 1-3 are intended as an example and not as an architectural limitation of the disclosed embodiments.

The disclosed description is presented with respect to embodiments of the present invention, which can be embodied in the context of a data-processing system such as, for example, data-processing system 100. The disclosed embodiments, however, are not limited to any particular application or any particular environment. Instead, those skilled in the art will find that the system and methods of the present invention may be advantageously applied to a variety of system and application software, including database management systems, docketing systems, word processors, spreadsheets, and the so forth. Moreover, the disclosed embodiments may be embodied on a variety of different platforms, including Macintosh, UNIX, LINUX, and the like. Therefore, the description of the exemplary embodiments, which follows, is for purposes of illustration and not considered a limitation.

Servers 240, 245, 247/or other servers (not shown) can be configured in some embodiments to act as redundant servers. That is, such servers can communicate with one another via the “cloud” or network 220. In this manner, data stored in server 240 can be synchronized with data stored in server 245 and/or other servers, so that if one server goes down the other server or servers can contain the same data and one does not need to worry about a loss of data. In some embodiments, server 240 may be located geographically in a distant location (e.g., the East Coast) from the other servers 245, 247, etc located at a different position (e.g., the West Coast).

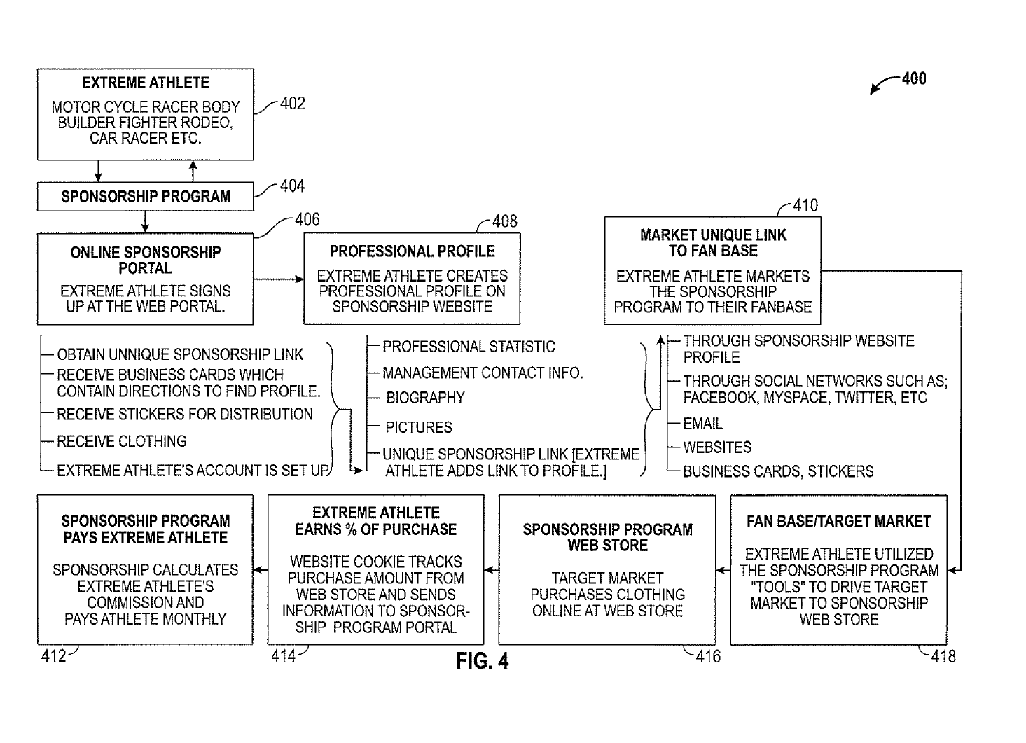

FIG. 4 illustrates a block diagram of a method 400 for electronically marketing a product through affiliate sponsorships via a computer network, such as, for example, network 210, in accordance with the disclosed embodiments. As indicated at block 402, a user, such as an “extreme athlete” can access a sponsorship program, as depicted at block 404. Note that an “extreme athlete” can be, for example, a motor cycle racer, body builder, MMA (Mixed Martial Arts) fighter, rodeo athlete, car racer, etc. Although discussed in the context of an extreme athlete, it can be appreciated that the aforementioned users may be other types of users. For example, an up and coming country and western artist, rock artist, classical musician, etc., may utilize the methods and systems discussed herein in the context of marketing products through affiliate sponsorships. The sponsorship program may be presented to such a user via an online sponsorship portal, as depicted at block 406.

In some embodiments, the web portal may be a website, or a web portal or links page configured as a website that functions as a point of access to information available via the World Wide Web. Such a portal can present information from diverse sources in a unified manner. Such web portals can provide a way to provide a consistent “look and feel” with access control and procedures for multiple applications and databases, which otherwise would have been different entities altogether.

The user can thus be presented with a single webpage that brings together or aggregates content from a number of other systems or servers. For portals that present application functionality to the user, the portal server is in reality the front piece of a server configuration that includes some connectivity to the application server. Service-Oriented Architecture (SOA) is one example of how the aforementioned web portal can be used to deliver application server content and functionality. The application server or architecture performs the actual functions of the application. This application server is in turn connected to database servers, and may be part of a clustered server environment. High-capacity portal configurations may include load balancing equipment. SOAP, an xml-based protocol, can in some embodiments be used for servers to communicate within this architecture.

The server hosting the portal may only be a “pass through” for the user. By use of portlets, application functionality can be presented in any number of portal pages. For the most part, this architecture is transparent to the user. In such a scheme, security and capacity can be important features, and administrators need to ensure that only an authorized visitor or user can generate requests to the application server. If administration does not ensure this aspect, then the portal may inadvertently present vulnerabilities to various types of attacks.

The user may sign up for the online sponsorship program via such a web portal or website. Such a web portal can be configured to allow the user (e.g., extreme athlete, musician, etc) to obtain a unique sponsorship link, receive business cards that contain directions to find his or profile, receive stickers for distribution, receive clothing, and set up his or her account. The user can create his or professional profile via the sponsorship website or portal, as indicated at block 408. Such a professional profile can include, for example, professional statistics, management contact information, biographical information, photos and/or other multimedia data, along with, in some embodiments, a unique sponsorship link (e.g., the user can add links to his or profile). Note that such profile information can be stored in, for example, a database such as, databases 230, 235, 249, etc depicted in FIG. 2. Such profile information may also be stored in, for example, a data storage unit such as data storage unit 308 shown in FIG. 3. Such profile information can also be stored in for example, memory 156 of FIG. 1 (e.g., profile data 128).

Next, as shown at block 410, the aforementioned unique link can be marketed to the user's fan base. That is, the user can market the aforementioned sponsorship program to his or fan base via she website portal, along with for example, the sponsorship website profile, or through, for example, social networks such as Facebook, MySpace, Twitter, etc. Marketing can also occur via other websites, e-mail, business cards, stickers, etc.

The user can make use of sponsorship program “tools” to drive a target market to his or her sponsorship web store, as depicted at block 418. The target market can purchase, for example, clothing or other items via the online webstore, as depicted at block 416. Thereafter, as described at block 414, the user can earn a percentage of the purchase. Websites cookies can track purchase amounts from the web store and sent information to the sponsorship program portal. The sponsorship program thus pays the user, as depicted at block 412. The sponsorship calculates a user's (e.g., extreme athlete) and pays the athlete monthly.

FIG. 5 illustrates a block diagram of a system 500 for marketing products through affiliate sponsorship via a computer network, such as, for example, network 220, in accordance with the disclosed embodiments. System 500 generally includes a plurality of modules, such as an online sponsorship web portal module 502, a profile/account module 504, a module 506 for generating and providing the unique sponsorship link described herein, a tracking module 508 for tracking purchase amounts from the web/online store discussed earlier and for sending information to the sponsorship program portal. System 500 can also include a payment module 510, which sends a commission amount to the user's account when a purchase is made. Payment module 510 can be configured to make such a payment to the user's account periodically or, for example, once a month for any purchases that were made from anyone who came to the online store via the user's unique sponsorship link. Such a system can therefore promote/market a product through a web portal or web registry and provide a sponsored individual (e.g., a user) with a percentage of any sale that is facilitated through his or unique sponsorship link (e.g., a web link).

In general, a website can be provided, which hosts software that provides the sponsored individual (i.e. user) the ability to sign up for account. The profile/account module 504 allows a user to sign up for such an account and the account can be associated with the unique sponsorship link, which may operate in some embodiments via the module 506. The user gives this link to his or her market base. When someone from the marked base clicks on this link, they are redirected to the online/website store. The online/website store can be provided by, for example, module 512 shown in FIG. 5. In some embodiments, the web cookie sends the commission amount to the user's account when the purchase is made. Thus, the tracking module 508 and the payment module 510 can function together to facilitate payment to the user based on such online purchases.

It can be appreciated that the disclosed embodiments can be implemented not only in the context of online websites, but also in the context of social networks. As indicated previously, network 220 can be, for example a social network.

FIG. 6 illustrates a block diagram of an example social networking system 100 in accordance with an embodiment described herein. As shown in FIG. 6, social networking system 100 can be configured to include a network manager 102 and a social network 104. Such a social network 104 can be provided via, for example, network 220 and/or a system such as system 300 shown in FIG. 3. Social network 104 can be communicatively connected to network manager 102 by a communication interface 106. Communication among user systems 108A-108N and communications between network manager 102 and any of user systems 108A-108N can be performed in accordance with well-known network communication protocols.

Social network 104 can be, for example, an online social network or a combination of social networks, that includes a community of users (network participating persons) who interact within social network 104 using respective user systems 108A-108N. Each of the user systems 108A-108N is a computer, a PDA, an HHD (e.g., tablet computing device, iPad type device, laptop computer, etc), Smartphone (e.g., iPhone, Blackberry, Android device, etc.), or other data-processing system or device, including one or more processors, which is configured to enable a user to provide social networking updates to other users in social network 104. For instance, each of the user systems 108A-108N includes a client 110 (e.g., a web browser such as web browser 215 shown in FIG. 2), which enables a respective user to provide such updates.

Social network 104 may include any number of user systems 108-108N, including hundreds, thousands, or even millions of user systems 108A-108N. Social network 104 operates within a communication network, such as a local area network (LAN), a wide area network (WAN), or a combination of networks, such as the Internet. For example, social network 104 may be based in the World Wide Web. The communication network enables communication between user systems 108A-108N. Social network 104 may enable one or more ways for users to interact, including enabling communications between user systems 108A-108N through one or more of blogging, discussion groups, email, file sharing, instant messaging, online chat, tweeting, video, voice chat, and/or other user communication mechanisms.

Network manager 102 can be, for example, a computer (e.g., Web server) or other processing system, including one or more processors, which is configured to take actions upon users in social networking system 100. Network manager 102 is capable of performing a compatibility analysis to determine users, purposes, and/or venues that are compatible with one another based on attributes associated with the respective users, purposes, and/or venues. For instance, network manager 102 may perform the compatibility analysis in response to receiving a request from a user via communication interface 106, though the scope of the example embodiments is not limited in this respect. The user may generate the request using a client 110, for example.

Example attributes of a user include but are not limited to interests (e.g., traveling, hiking, art, etc.), preferences (e.g., four star hotel, educational activities, etc.), and/or requirements (e.g., peanut allergy, acrophobia, etc.) of the user. Example attributes of a purpose include but are not limited to breakfast, lunch, dinner, food, tomorrow, weekend, movie, golf, tennis, happy hour, birthday party, volunteer, study session, girls' night out, museum tour, cruise, shopping, vacation, business strategy meeting, etc. A venue may be a restaurant, a golf course, a bar, a sports stadium, a concert arena, a hotel, a library, a museum, a retail store, a mall, a ship, a country, a state, a city, another geographical region, etc. Attributes of a venue may be dependent on the type of venue. For instance, attributes of a restaurant may include steak, burger, ice cream, five star, business casual, sea food, Chinese, gourmet, outdoor seating, or any other suitable attribute.

The attributes of the respective users, purposes, and/or venues may be represented by metadata associated with the respective users, purposes, and/or venues. A tag is a type of metadata that enables a user, purpose, or venue that is represented by the tag to be found in accordance with a browsing or searching operation. Some example embodiments are described herein with reference to tags and are not intended to be limiting. Persons skilled in the relevant art(s) will recognize that any suitable type of metadata may be used to represent a user, purpose, and/or venue.

In some embodiments of social network 104, tags may include respective polarity indicators. A polarity indicator that is included in a tag may indicate whether an attribute that is represented by the tag is compatible with the user, purpose, or venue with which the tag is associated. For example, the polarity indicator may specify a positive polarity, a negative polarity, or an unknown polarity. In accordance with this example, a polarity indicator that specifies a positive polarity may indicate that the attribute represented by the respective tag is compatible with the user, purpose, or venue. For instance, a tag that represents a user attribute of “peanuts” may include a polarity indicator that specifies a positive polarity to indicate that the user likes peanuts. A polarity indicator that specifies a negative polarity may indicate that the attribute represented by the respective tag is not compatible with the user, purpose, or venue. For instance, a tag that represents a user attribute of “peanuts” may include a polarity indicator that specifies a negative polarity to indicate that the user does not like peanuts, that the user is allergic to peanuts, etc. A polarity indicator that specifies an unknown polarity may indicate that it is unknown whether the attribute represented by the respective tag is compatible with the user, purpose, or venue. For instance, a tag that represents a user attribute of “peanuts” may include a polarity indicator that specifies an unknown polarity to indicate that it is unknown whether the user likes peanuts, whether the user is allergic to peanuts, etc.

In another example, a tag may be a positive tag or a negative tag. In accordance with this example, a polarity indicator need not be used to indicate whether an attribute is compatible with a user, purpose, or venue. For instance, a positive tag may indicate that an attribute that is represented by the tag is compatible with the user, purpose, or venue with which the tag is associated. A negative tag may indicate that an attribute that is represented by the tag is not compatible with the user, purpose, or venue with which the tag is associated. The distinction between a positive tag and a negative tag may be derived from the contents of the tag. For instance, a user tag of “peanuts” may indicate that the user likes peanuts; whereas, a user tag of “no peanuts” may indicate that the user does not like peanuts, that the user is allergic to peanuts, etc. Accordingly, the user tag of “peanuts” may be referred to as a positive tag, and the user tag of “no peanuts” may be referred to as a negative tag.

Network manager 102 is further capable of taking action upon the users (or a subset thereof) in social networking system 100 based on the compatibility analysis. Example actions include but are not limited to recommending user(s), purpose(s), and/or venue(s); inviting user(s) to join a group, to attend an event, or to perform an action; etc. Various techniques for taking action upon users in a social networking system are known in the social networking arts and in the interest of brevity are not described herein.

Network manager 102 may be configured to provide a graphical user interface that includes interface elements that represent respective users, purposes, and/or venues. In accordance with an example implementation, network manager 102 performs a compatibility analysis with respect to the users, purposes, and/or venues based on the configuration of the interface elements. For example, proximity of the interface elements to one another may determine which users, purposes, and/or venues are included in the compatibility analysis. In accordance with this example, overlapping interface elements may indicate that the compatibility of those interface elements can be determined utilizing a compatibility analysis.

In accordance with another example implementation, the configuration of the interface elements is determined based on a compatibility analysis that is performed with respect to the users, purposes, and/or venues. For example, the proximity of the interface elements to one another in the graphical user interface may be based on the compatibility analysis. In accordance with this example, a closer proximity may represent a greater compatibility. A farther proximity may represent a lesser compatibility.

At least some of the interface elements may be movable in the graphical user interface by a user via a client 110, for example, though the scope of the example embodiments is not limited in this respect. For instance, moving an interface element in the graphical user interface may cause an update indicator that specifies an updated configuration of the interface elements to be provided by the client 110 to network manager 102.

Network manager 102 may in some embodiments, perform a compatibility analysis with respect to the users, purposes, and/or venues based on the updated configuration of the interface elements. For instance, network manager 102 may be configured to automatically perform the compatibility analysis in response to receipt of the update indicator that specifies the updated configuration. Network manager 102 may be further configured to take an action based on results of the compatibility analysis regarding the updated configuration. For instance, network manager 102 may be configured to automatically take the action in response to performance of the compatibility analysis that is based on the updated configuration. Techniques for using a graphical user interface in accordance with a compatibility analysis are well known and thus in the interest of brevity, will not be discussed herein.

In accordance with example embodiments, network manager 102 can be further configured to manage communications in social networking system 100. For example, network manager 102 may handle delivery of recommendations and/or invitations to users in social networking system 100 based on compatibility analyses regarding the users. In another example, network manager 102 may handle delivery of social networking updates among users in social networking system 100.

In order for a network manager 102 to determine compatibility of a plurality of users as a whole with a purpose and/or a venue, user domain tags that represent respective cumulative attributes of the plurality of users may be determined, though the scope of the example embodiments is not limited in this respect. For instance, a first plurality of attributes, which is associated with the plurality of respective users, may pertain to peanuts. The first plurality of attributes may be analyzed to determine a cumulative peanut attribute associated with the plurality of users as a whole. A second plurality of attributes, which is associated with the plurality of respective users, may pertain to hiking. The second plurality of attributes may be analyzed to determine a cumulative hiking attribute associated with the plurality of users as a whole, and so on. The example attributes described herein are provided for illustrative purposes and are not intended to be limiting. It will be recognized that example embodiments may utilize any suitable attributes.

Any number of social networks may be utilized in accordance with the disclosed embodiments. That is, the unique sponsorship link discussed herein can be utilized anywhere it is placed, such as in social networks such as Facebook, Myspace, along with e-mail and other websites. Anywhere that the link is placed it is live and will redirect anyone who “clicks” on it (i.e., selects the link) to the website store provided by, for example, the module 512 shown in FIG. 5. All purchases are tracked to the user's account as discussed herein.

One example of a social network that may be utilized in accordance with an embodiment is disclosed in U.S. Patent Application Publication No. US 20110126121 entitled “Marketing System Having Multiple Fulfillment Channels And A Method for Directing a Personalized Invitation To Members Of A Social Network,” which published to Farmer et al on May 26, 2011 and is incorporated herein by reference in its entirety. A further example of a social network that can be adapted for use with one or more embodiments is disclosed in U.S. Patent Application Publication No. 20110055725, entitled “Taking Action Upon Users In A Social Networking System With Respect to a Purpose Based On Compatibility Of The Users To The Purpose,” which published on Mar. 3, 2011 to Folgner et al, and which is incorporated herein by reference in its entirety. Another example of a social network and related applications, which can be utilized in accordance with another embodiment is disclosed in U.S. Pat. No. 7,865,592 entitled “Using Semantic Networks To Develop A Social Network,” which issued to Chakra et al on Jan. 4, 2011 and is also incorporated herein by reference in its entirety. A further example of a social network that may be utilized in accordance with another embodiment is disclosed in U.S. Patent Application Publication No. 20080154739 entitled “Social Network Commerce Model,” which published on Jun. 26, 2008 to Chris Kalaboukis, and which is incorporated herein by reference in its entirety.

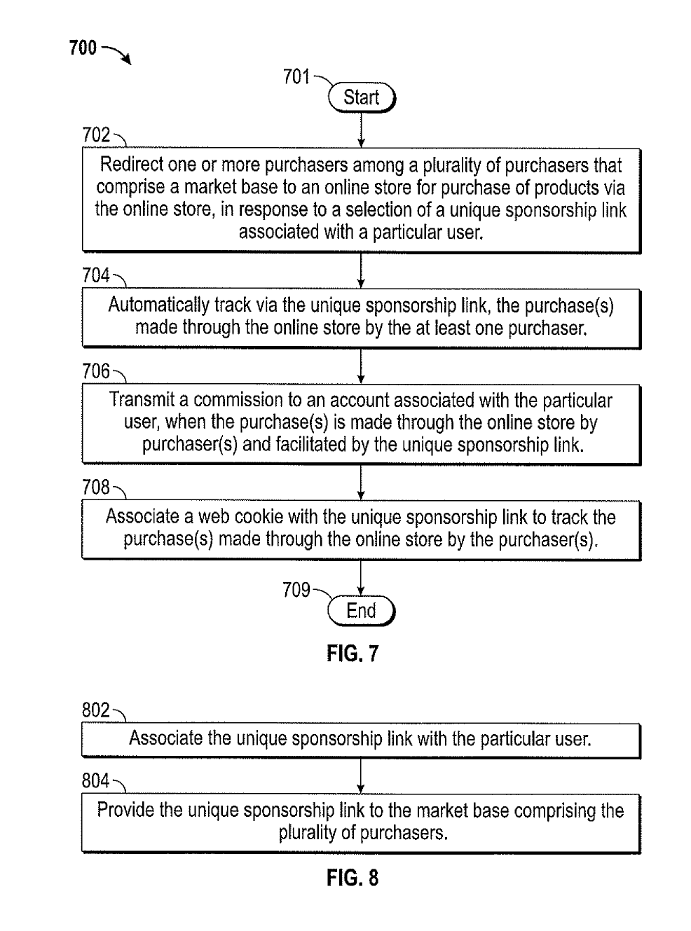

FIG. 7 illustrates a high level flow chart of logical operational steps of a social networking sponsorship method 700 that can be implemented in accordance with an embodiment. As indicated at block 701, the process is initiated. Then, as indicated at block 702, a step or logical operation can be implemented for redirecting one or more purchases among a plurality of purchases that comprise a market base to an online store (e.g., website) for purchase of a products via the online store, in response to a selection of a unique sponsorship link associated with a particular user. Thereafter, as depicted at block 704 a step or logical operation can be implemented for automatically tracking via the unique sponsorship link, the purchase(s) made through the online store by the purchaser(s) (i.e., the at least one purchaser). Next, a step or operation can be implemented as shown at block 706 to transmit a commission to an account (e.g., a financial account, bank account, PayPal account, etc) associated with the particular user, when the purchase(s) is made through the online store by the purchaser(s) and facilitated by the unique sponsorship link. Thereafter, as indicated at block 708, a step or logical operation can be implemented for associated a web cookie with the unique sponsorship link to track the purchase(s) made through the online store by the purchaser(s). The process can then end (or not) as indicated at block 709.

FIG. 8 illustrates additional logical operational steps of a social networking sponsorship method 802 than can be implemented in accordance with an embodiment. Note that the steps or logical operations shown at blocks 802 and 804 in FIG. 8 can be utilized in association with the steps/operations depicted in FIG. 7 or may replace or complement the method 700. Thus, as indicated at block 802, a step or operation can be implemented for associated the unique sponsorship link with the particular user (or users). Thereafter, a step or logical operation can be implemented for providing the unique sponsorship link the mark base comprising the plurality of purchasers.

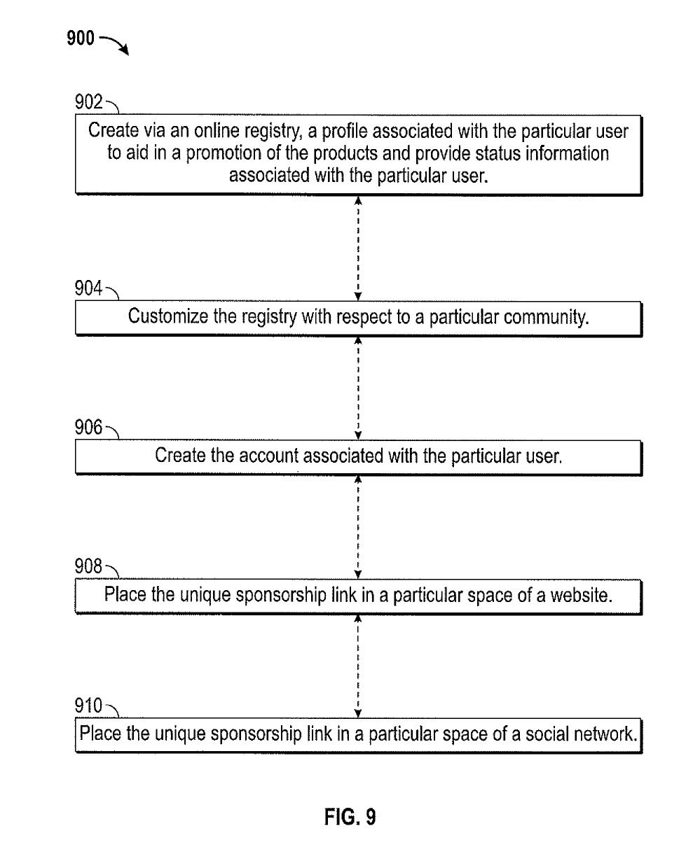

FIG. 9 illustrates additional logical operational steps of a social networking sponsorship method 900 than can be implemented in accordance with an embodiment. The steps or logical operations shown at blocks 902 to 910 in FIG. 9 can be utilized with the methods and steps/operations shown in FIG. 7-8. Dashed arrows indicate that the steps may be individually separated from one another and combined or associated with the operations shown in FIGS. 7-8 or may be combined together to implement particular operations. Thus, block 902 indicates a step or logical operation for creating via an online registry (e.g., database), a profile associated with the particular user to aid in a promotion of the products) and provide status information associated with the particular user. Block 904 indicates a step or operation that can be implemented for customizing the registry with respect to a particular community. Block 906 indicates a step or operation for creating the account associated with the particular user. Block 908 indicates a step or operation for placing the unique sponsorship link in a particular space of a website. Block 910 indicates a step or operation for placing the unique sponsorship link in a particular space of a social network such as, for example, the social network 104 discussed herein (e.g., Facebook, Google +, etc).

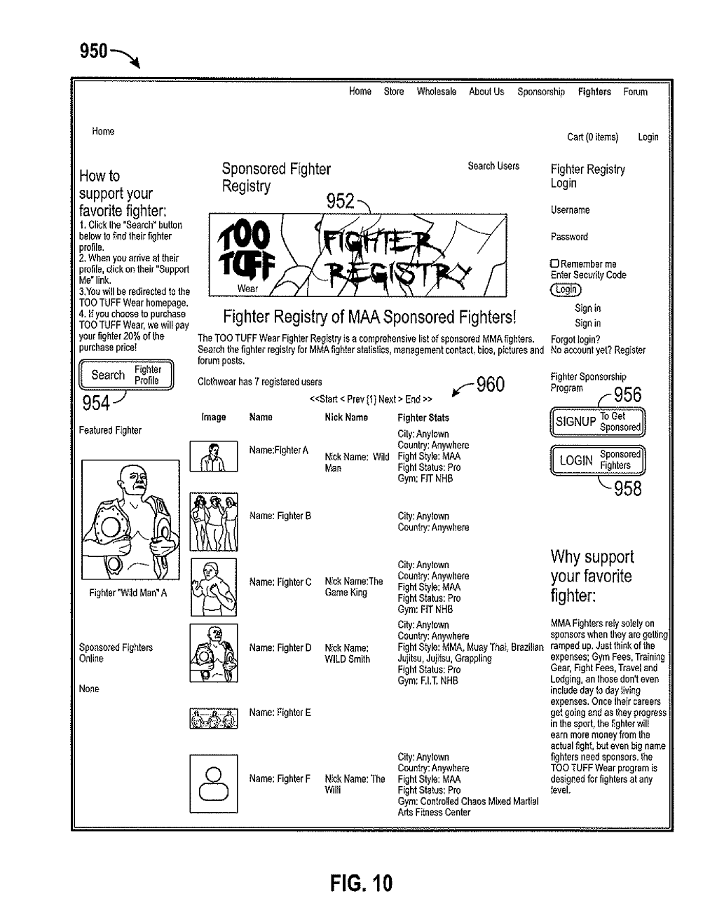

FIG. 10 illustrates a pictorial view of an example sponsorship webpage 950 in accordance with an embodiment. The webpage 950 includes a number of graphically displayed features such as, for example, a button 954 for implementing a profile search (e.g. a fighter profile search). An area 960 can display images of members, fighters, etc., along with names and statistical information, etc. A graphical button 956, when selected by a user, permits that user to sign up an obtain sponsorship. A graphical button 958 permits a user to login (e.g., sponsored fighter). An area 952 can be “clicked” by a user to select/access the registry (e.g., fighter registry/database).

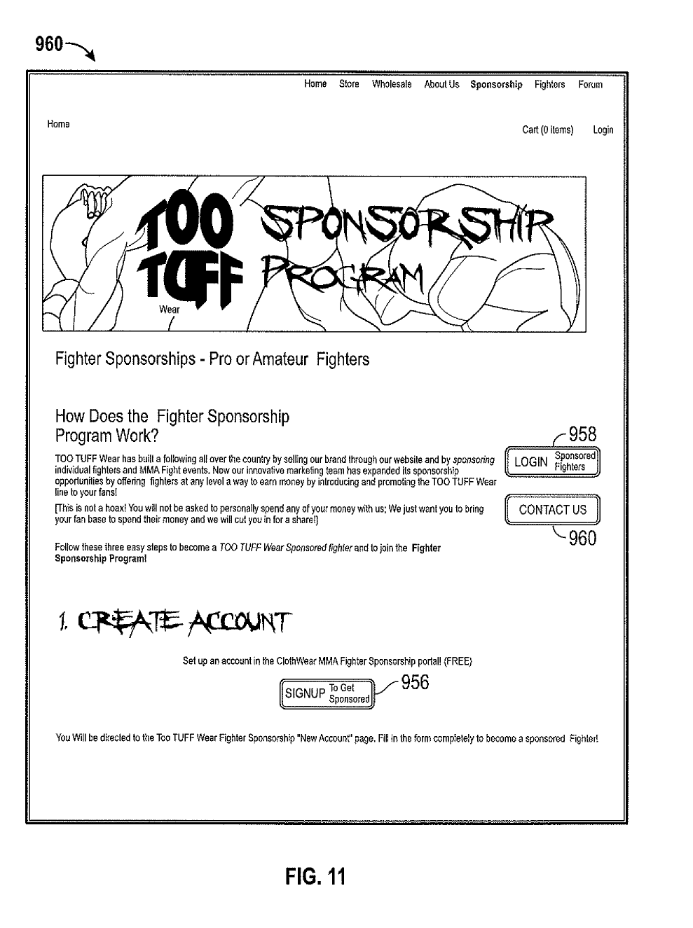

FIG. 11 illustrates a pictorial view of an example sponsorship webpage 960 in accordance with an embodiment that includes information about how the sponsorship program works. Webpage 960 includes an area for creating an account via selection of button 956. A login button 958 for sponsored fighters is also shown in FIG. 11, along with a button that when selected allows a user to contact the website/sponsorship owners/operators.

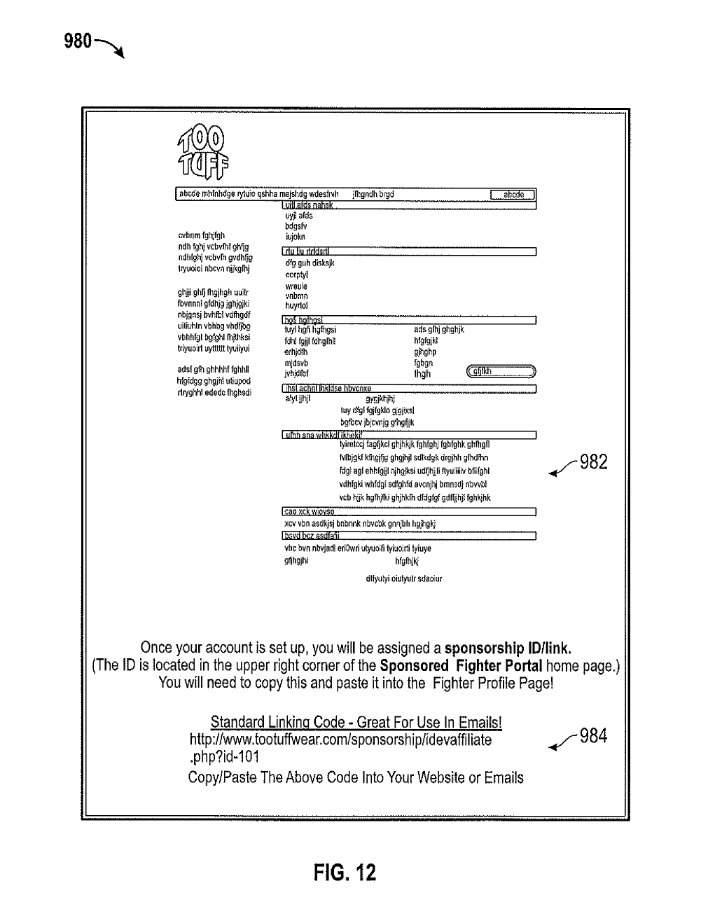

FIG. 12 illustrates a pictorial view of an example sponsorship webpage 980 including an informational placeholder 982 and a linking code 984, in accordance with an embodiment. Webpage 980 allows a user, once the account is set up, to be assigned a sponsorship ID/link. The ID and/or link can be copied and pasted into a profile page.

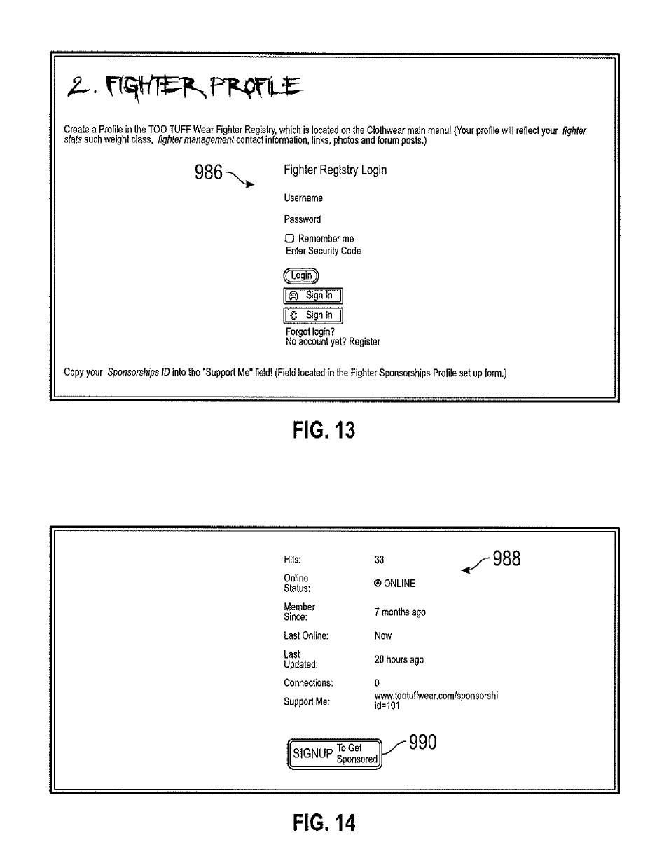

FIG. 13 illustrates a pictorial view of an example sponsorship webpage including data input buttons for accessing a registry/database in accordance with an embodiment. The webpage shown in FIG. 13 contains includes an area 986 where a user can enter his or her username/password and to login the fighter registry.

FIG. 14 illustrates a pictorial view of an example sponsorship webpage including graphical input buttons to select and sign up for a sponsorship in accordance with an embodiment. The webpage shown in FIG. 14 includes an area 988 that indicates online status, how long the user has been a member, when his or her information was last update and a sponsorship link. A graphical button 990 when selected by a user allows a user to sign up for the sponsorship program.

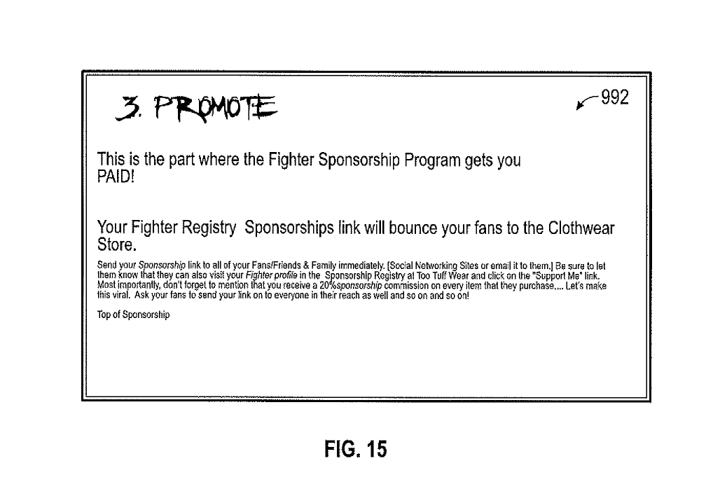

FIG. 15 illustrates a pictorial view of an example sponsorship webpage including additional information regarding a sponsorship program, in accordance with an embodiment. The information 992 shown in the webpage depicted in FIG. 15 indicates in one scenario where the registry sponsorship link will “bounce” a user's fans to an online clothing store. Additional details of the sponsorship program are also described in FIG. 15.

Based on the foregoing, it can be appreciated that a number of embodiments, preferred and/or alternative, are disclosed. For example, an embodiment can be implemented as a method for electronically marketing a product through affiliate sponsorships via a computer network. Such a method may include the steps of, for example, redirecting at least one purchaser among a plurality of purchasers that comprise a market base to an online store for purchase of products via the online store, in response to a selection of a unique sponsorship link associated with a particular user; automatically tracking via the unique sponsorship link, at least one purchase made through the online store by the at least one purchaser; and transmitting a commission to an account associated with the particular user, when the at least one purchase is made through the online store by the at least one purchaser and facilitated by the unique sponsorship link.

In another embodiment, steps can be implemented for associating the unique sponsorship link with the particular user, and providing the unique sponsorship link to the market base comprising the plurality of purchasers. In another embodiment, a step can be provided for creating via an online registry, a profile associated with the particular user to aid in a promotion of the products and provide status information associated with the particular user. In still other embodiments, a step can be provided for customizing the registry with respect to a particular community.

In other embodiments, a step can be provided for creating the account associated with the particular user. In yet other embodiments, a step can be provided for placing the unique sponsorship link in a particular space of a website. In other embodiments, a step can be provided for placing the unique sponsorship link in a particular space of a social network. In still other embodiments, the step of automatically tracking via the unique sponsorship link can further include a step of associating a web cookie with the unique sponsorship link to track at least one purchase made through the online store by the at least one purchaser.

In still other embodiments, a system can be provided for electronically marketing a product through affiliate sponsorships via a computer network. Such a system can include, for example, a processor, and a data bus coupled to the processor. Such a system can also include a computer-usable medium embodying computer code. The computer-usable medium can be coupled to the data bus. The computer program code can comprise instructions executable by the processor and configured for redirecting at least one purchaser among a plurality of purchasers that compose a market base to an online store for purchase of products via the online store, in response to a selection of a unique sponsorship link associated with a particular user; automatically tracking via the unique sponsorship link, at least one purchase made through the online store by the at least one purchaser; and transmitting a commission to an account associated with the particular user, when the at least one purchase is made through the online store by the at least one purchaser and facilitated by the unique sponsorship link.

In other embodiments, such instructions can be further configured for associating the unique sponsorship link with the particular user, and providing the unique sponsorship link to the market base comprising the plurality of purchasers. In other embodiments, such instructions can be further configured for creating via an online registry, a profile associated with the particular user to aid in a promotion of the products and provide status information associated with the particular user. In other embodiments, such instructions can be further configured for customizing the registry with respect to a particular community. In still other embodiments, such instructions can be further configured for creating the account associated with the particular user and the profile.

In yet other embodiments such instructions can be further configured for placing the unique sponsorship link in a particular space of a website. In still other embodiments, such instructions can be further configured for placing the unique sponsorship link in a particular space of a social network. In still other embodiments, the aforementioned instructions for automatically tracking via the unique sponsorship link, can further comprise instructions for associating a web cookie with the unique sponsorship link to track at least one purchase made through the online store by the at least one purchaser. Alternatively, instructions for associating a web cookie with the unique sponsorship link to track at least one purchase made through the online store by the at least one purchaser, can be standalone instructions separate from instructions for automatically tracking via the unique sponsorship link.

In still another embodiment, a processor-readable medium can be provided for storing code representing instructions to cause a processor to perform a process for electronically marketing a product through affiliate sponsorships via a computer network. Such code may comprise code to, for example: redirect at least one purchaser among a plurality of purchasers that comprise a market base to an online store for purchase of products via the online store, in response to a selection of a unique sponsorship link associated with a particular user; automatically track via the unique sponsorship link, at least one purchase made through the online store by the at least one purchaser; and transmit a commission to an account associated with the particular user, when the at least one purchase is made through the online store by the at least one purchaser and facilitated by the unique sponsorship link.

In another embodiment, such code can further comprise code to associate the unique sponsorship link with the particular user, and provide the unique sponsorship link to the market base comprising the plurality of purchasers. In yet other embodiments, such code can further comprise code to create via an online registry, a profile associated with the particular user to aid in a promotion of the products and provide status information associated with the particular user. In still other embodiments, such code can further comprise code to customize the registry with respect to a particular community. In yet other embodiments, such code can further comprise code to create the account associated with the particular user. In yet other embodiments, such code can comprise code to place the unique sponsorship link in a particular space of a website. In still other embodiments, such code can further comprise code to place the unique sponsorship link in a particular space of a social network. In other embodiments, such code can further comprise code to associate a web cookie with the unique sponsorship link to track at least one purchase made through the online store by the at least one purchaser.

In still other embodiments, a method for electronically marketing a product through affiliate sponsorships via a computer network can be provided. Such a method may include, for example, the steps of redirecting at least one purchaser among a plurality of purchasers that comprise a market base to an online store for purchase of products via the online store, in response to a selection of a unique sponsorship link associated with a particular user; automatically tracking via the unique sponsorship link, at least one purchase made through the online store by the at least one purchaser; and transmitting a commission to an account associated with the particular user, when the at least one purchase is made through the online store by the at least one purchaser and facilitated by the unique sponsorship link; and associating a web cookie with the unique sponsorship link to track at least one purchase made through the online store by the at least one purchaser.

In another embodiment of such a method, steps may be provided for associating the unique sponsorship link with the particular user, and providing the unique sponsorship link to the market base comprising the plurality of purchasers. In another embodiment of such a method, steps can be provided for creating via an online registry, a profile associated with the particular user to aid in a promotion of the products and provide status information associated with the particular user. In still other embodiments of such a method, a step can be implemented for customizing the registry with respect to a particular community. In still other embodiments of such a method, a step can be provided for creating the account associated with the particular user. In yet other embodiments of such a method, a step can be provided for placing the unique sponsorship link in a particular space of a website. In other embodiments of such a method a step can be implemented for placing the unique sponsorship link in a particular space of a social network.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for electronically marketing a product through affiliate sponsorships via a computer network, comprising:
redirecting at least one purchaser among a plurality of purchasers that comprise a market base to an online store for purchase of products via said online store, in response to a selection of a unique sponsorship link associated with a particular user;
automatically tracking via said unique sponsorship link, at least one purchase made through said online store by said at least one purchaser; and
transmitting a commission to an account associated with said particular user, when said at least one purchase is made through said online store by said at least one purchaser and facilitated by said unique sponsorship link.

2. The method of claim 1 further comprising:
associating said unique sponsorship link with said particular user;
providing said unique sponsorship link to said market base comprising said plurality of purchasers.

3. The method of claim 1 further comprising creating via an online registry, a profile associated with said particular user to aid in a promotion of said products and provide status information associated with said particular user.

4. The method of claim 3 further comprising customizing said registry with respect to a particular community.

5. The method of claim 3 further comprising creating said account associated with said particular user.

6. The method of claim 5 further comprising placing said unique sponsorship link in a particular space of a website.

7. The method of claim 5 further comprising placing said unique sponsorship link in a particular space of a social network.

8. The method of claim 1 wherein automatically tracking via said unique sponsorship link, further comprises:
associating a web cookie with said unique sponsorship link to track at least one purchase made through said online store by said at least one purchaser.

9. A system for electronically marketing a product through affiliate sponsorships via a computer network, comprising:
a processor;
a data bus coupled to said processor; and
a computer-usable medium embodying computer code, said computer-usable medium being coupled to said data bus, said computer program code comprising instructions executable by said processor and configured for:
redirecting at least one purchaser among a plurality of purchasers that compose a market base to an online store for purchase of products via said online store, in response to a selection of a unique sponsorship link associated with a particular user;
automatically tracking via said unique sponsorship link, at least one purchase made through said online store by said at least one purchaser; and
transmitting a commission to an account associated with said particular user, when said at least one purchase is made through said online store by said at least one purchaser and facilitated by said unique sponsorship link.

10. The system of claim 9 wherein said instructions are further configured for:
associating said unique sponsorship link with said particular user; and
providing said unique sponsorship link to said market base comprising said plurality of purchasers.

11. The method of claim 9 wherein said instructions are further configured for creating via an online registry, a profile associated with said particular user to aid in a promotion of said products and provide status information associated with said particular user.

12. The system of claim 11 wherein said instructions are further configured for customizing said registry with respect to a particular community.

13. The system of claim 11 wherein said instructions are further configured for creating said account associated with said particular user and said profile.

14. The system of claim 13 are further configured for placing said unique sponsorship link in a particular space of a website.

15. The system of claim 13 are further configured for placing said unique sponsorship link in a particular space of a social network.

16. The system of claim 9 wherein said instructions for automatically tracking via said unique sponsorship link, further comprise:
instructions for associating a web cookie with said unique sponsorship link to track at least one purchase made through said online store by said at least one purchaser.

17. A processor-readable medium storing code representing instructions to cause a processor to perform a process for electronically marketing a product through affiliate sponsorships via a computer network, said code comprising of code to:
redirect at least one purchaser among a plurality of purchasers that comprise a market base to an online store for purchase of products via said online store, in response to a selection of a unique sponsorship link associated with a particular user;
automatically track via said unique sponsorship link, at least one purchase made through said online store by said at least one purchaser; and
transmit a commission to an account associated with said particular user, when said at least one purchase is made through said online store by said at least one purchaser and facilitated by said unique sponsorship link.

18. The processor-readable medium of claim 17 wherein said code further comprises code to:
associate said unique sponsorship link with said particular user;
provide said unique sponsorship link to said market base comprising said plurality of purchasers.

19. The processor-readable medium of claim 17 wherein said code further comprises code to create via an online registry, a profile associated with said particular user to aid in a promotion of said products and provide status information associated with said particular user.

20. The processor-readable medium of claim 19 wherein said code further comprises code to customize said registry with respect to a particular community.

21. The processor-readable medium of claim 19 wherein said code further comprises code to create said account associated with said particular user.

22. The processor-readable medium of claim 21 wherein said code further comprises code to place said unique sponsorship link in a particular space of a website.

23. The processor-readable medium of claim 21 wherein said code further comprises code to place said unique sponsorship link in a particular space of a social network.

24. The processor-readable medium of claim 17 wherein said code further comprises code to:
associate a web cookie with said unique sponsorship link to track at least one purchase made through said online store by said at least one purchaser.

25. A method for electronically marketing a product through affiliate sponsorships via a computer network, comprising:
redirecting at least one purchaser among a plurality of purchasers that comprise a market base to an online store for purchase of products via said online store, in response to a selection of a unique sponsorship link associated with a particular user;
automatically tracking via said unique sponsorship link, at least one purchase made through said online store by said at least one purchaser; and
transmitting a commission to an account associated with said particular user, when said at least one purchase is made through said online store by said at least one purchaser and facilitated by said unique sponsorship link; and
associating a web cookie with said unique sponsorship link to track at least one purchase made through said online store by said at least one purchaser.

26. The method of claim 25 further comprising:
associating said unique sponsorship link with said particular user;
providing said unique sponsorship link to said market base comprising said plurality of purchasers.

27. The method of claim 25 further comprising creating via an online registry, a profile associated with said particular user to aid in a promotion of said products and provide status information associated with said particular user.

28. The method of claim 27 further comprising customizing said registry with respect to a particular community.

29. The method of claim 27 further comprising creating said account associated with said particular user.

30. The method of claim 29 further comprising placing said unique sponsorship link in a particular space of a website.

31. The method of claim 29 further comprising placing said unique sponsorship link in a particular space of a social network.
